(19) United States
(12) Patent Application Publication
(10) Pub. No.: US 2013/0208605 A1
(43) Pub. Date: Aug. 15, 2013

(54) METHOD AND APPARATUS FOR UE-BASED HANDOVER DURING NETWORK COVERAGE HOLES

(71) Applicants: Jose Edson Vargas Bautista, San Diego, CA (US); Francisco Pica, San Diego, CA (US); Bhupesh Manoharlal Umatt, Poway, CA (US); Thomas Klingenbrunn, San Diego, CA (US); Krishna Rao Mandadapu, San Diego, CA (US)

(72) Inventors: Jose Edson Vargas Bautista, San Diego, CA (US); Francisco Pica, San Diego, CA (US); Bhupesh Manoharlal Umatt, Poway, CA (US); Thomas Klingenbrunn, San Diego, CA (US); Krishna Rao Mandadapu, San Diego, CA (US)

(73) Assignee: QUALCOMM Incorporated, San Diego, CA (US)

(21) Appl. No.: 13/586,146

(22) Filed: Aug. 15, 2012

Related U.S. Application Data
(60) Provisional application No. 61/582,933, filed on Jan. 4, 2012.

(51) Int. Cl. H04W 36/14

(52) U.S. Cl. CPC H04W 36/14
USPC 370/252

(57) ABSTRACT

Apparatus and methods are described herein for efficiently handing over a user equipment from an earlier-technology network back to a later-technology network upon detecting the end of a coverage hole in the later-technology network. The UE may be configured to measure signals from the later-technology network. When the UE discovers, upon establishment or reestablishment of a PS data connection, that the later-technology network signal exceeds a defined threshold, the UE may initiate a handover back to the later-technology network.

### CLAIM OF PRIORITY UNDER 35 U.S.C. §119

The present application for patent claims priority to Provisional Application No. 61/582,933 entitled “Method and Apparatus for UE-Based Handover During Network Coverage Holes” filed Jan. 4, 2012, and assigned to the assignee hereof and hereby expressly incorporated by reference herein.

### BACKGROUND

Aspects of the present disclosure relate generally to wireless communication systems, and more particularly, to handovers from an earlier-technology network to a later-technology network

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications. Enhanced UMTS Terrestrial Radio Access Network (E-UTRAN) technologies, such as Long Term Evolution (LTE) are also becoming more prevalent.

### SUMMARY

Apparatus and methods are described herein for efficiently handing over a user equipment from an earlier-technology network back to a later-technology network upon detecting the end of a coverage hole in the later-technology network. The UE may be configured to, while connected to the earlier-technology network for PS only services, measure signals from the later-technology network. When the UE autonomously discovers that the later-technology network signal exceeds a defined threshold, the UE may expedite a connection release from the earlier-technology network and initiate a reselection procedure back to the later-technology network.

In one aspect, the disclosure provides a method of wireless communication comprising detecting, by a user equipment, movement from a later-technology network to an earlier-technology network; detecting a connection for a packet-switched data call in the earlier-technology network; performing, autonomously and in response to determining the connection, one or more measurements to determine that the later-technology network is available; and autonomously triggering a connection release from the earlier-technology and a reselection to the later-technology network when the signal of the later technology network is available (for example, above a certain threshold), based on the one or more measurements.

Another aspect of the disclosure provides an apparatus for wireless communication comprising at least one processor configured to detect movement from a later-technology network to an earlier-technology network; detect a connection for a packet-switched data call in the earlier-technology network; perform, autonomously and in response to determining the connection, one or more measurements to determine that the later-technology network is available; and trigger a connection release from the earlier-technology and a reselection to the later-technology network when the signal of the later technology network is above a certain threshold, based on the one or more measurements; and a memory coupled to the at least one processor.

Yet another aspect of the disclosure provides an apparatus comprising means for detecting movement from a later-technology network to an earlier-technology network; means for detecting a connection for a packet-switched data call in the earlier-technology network; means for performing, autonomously and in response to determining the connection, one or more measurements to determine that the later-technology network is available; and means for triggering a connection release from the earlier-technology and a reselection to the later-technology network when the signal of the later technology network is above a certain threshold, in response to the one or more measurements.

These and other aspects of the invention will become more fully understood upon a review of the detailed description, which follows.

### BRIEF DESCRIPTION OF THE DRAWINGS

FIG. 1 illustrates a communications system implementing various aspects of the disclosure.

FIG. 2 is a block diagram of a handover manager for implementing various aspects of the disclosure.

FIG. 3 is a block diagram illustrating an example of a user equipment for implementing various aspects of the disclosure.

FIG. 4 if a flowchart of a method for UE-based handover, in accordance with various aspects of the disclosure.

FIG. 5 is another flowchart of a method for UE-based handover, in accordance with various aspects of the disclosure.

FIG. 6 is a timing diagram conceptually illustrating an example method for UE-based handover.

FIG. 7 is a block diagram illustrating an example of a hardware implementation for an apparatus employing a processing system.

FIG. 8 is a conceptual block diagram illustrating an apparatus for UE-based handover.

FIG. 9 is a block diagram conceptually illustrating an example of a telecommunications system.

FIG. 10 is a conceptual diagram illustrating an example of an access network.

FIG. 11 is a conceptual diagram illustrating an example of a radio protocol architecture for the user and control plane.

FIG. 12 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The apparatus and methods described herein provide a mechanism allowing a user equipment (UE) to autonomously move from an earlier technology network back to a later technology network after exiting a coverage hole associated with the later technology network. In accordance with some aspects, the earlier technology network may be, for example, a 2G or 3 G communication network while the later technology network may be a 4G or later communication network. The UE may be configured to perform, autonomously, periodic measurements to determine whether communication can be reestablished in the later technology network. Upon determining that communication can be reestablished, the UE may initiate a handover process to return it to the later technology network.

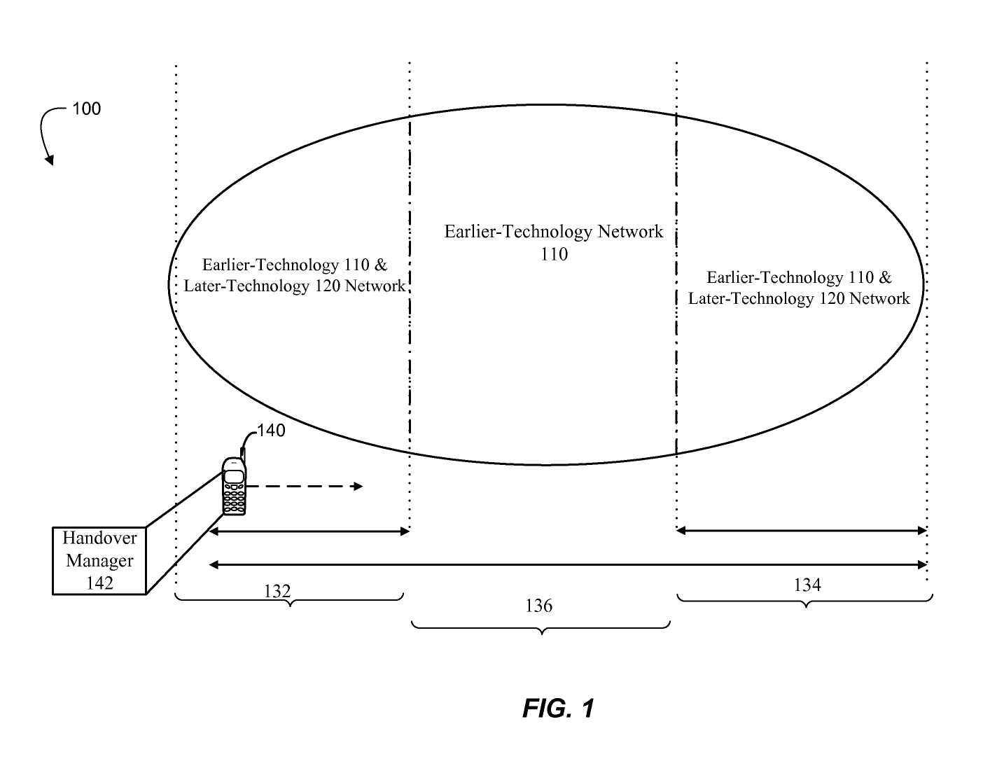

FIG. 1 depicts an exemplary communication system 100 implementing various aspects of this disclosure. Communication system 100 may include earlier technology network 110 and a later technology network 120 having overlapping coverage areas with the earlier technology network 110, as shown at 132, 134. No later technology network 120 coverage is available in the area depicted by 136, forming a later technology network coverage hole. Earlier technology network 110 may include any communication technology or communication technology version older than later technology network 120. For example, earlier technology network 110 may be a 3G or 2G network, while later technology network 120 may be a 4G network.

A UE 140 may be configured to communicate via both earlier technology network 110 and later technology network 120. In some aspects, later technology network 120 may have priority over earlier technology network 110. That is, UE 140 may be configured to connect to later technology network 120 whenever coverage is available. For example, the UE 140 may be configured to connect to the later-technology network 120 when the later-technology signal strength is above a defined threshold. As UE 140 moves through communication system 100, UE 140 may encounter a later technology network 120 coverage hole 136. Thus, communication will be handed over to earlier technology network 110.

A typical UE in CONNECTED mode lacks an autonomous mechanism for returning to a later technology network after the end of a coverage hole. Additionally, typical UEs in IDLE mode may remain connected to an earlier technology network if spurious traffic is generated by the mobile operating system or application. As shown in FIG. 1, UE 140 may include a handover manager 142 configured to detect that the later technology network is once again available after encountering a coverage hole, and to initiate a reselection back to the later technology network if the target signal is above a certain threshold.

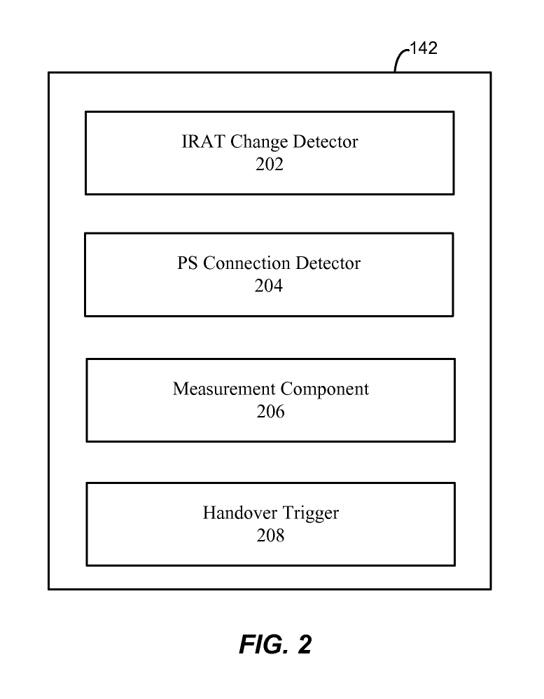

FIG. 2 depicts handover manager 142 in further detail. Handover manager 142 may include an Inter-Radio Access Technology (IRAT) change detector 202. IRAT change detector 202 may be configured to detect changes from one access technology to another. For example, IRAT change detector 202 may be configured to detect a change from later-technology network 120 to earlier-technology network 110. In some aspects, IRAT change detector 202 detects a handover from the later-technology network to the earlier-technology network when the UE is in a CONNECTED mode upon entering a later-technology network coverage hole. In other aspects, IRAT change detector 202 detects a cell reselection when the UE is in an IDLE mode upon entering a later-technology network coverage hole.

Certain later-technology networks support only packet-switched (PS) communications. As such, it would not be desirable to attempt to switch from an earlier-technology network to a later-technology network during a circuit-switched (CS) call. PS connection detector 204 may be configured to detect communications for packet-switched data. For example, once IRAT change detector 202 has detected a change from a later-technology network to an earlier-technology network, PS connection detector 204 may be configured to detect whether a packet-switched communication session has also been established. In some aspects, the packet-switched communication session may be a user-initiated and/or user-controlled data session. In other aspects, the packet-switched communication session may be an operating system and/or application-controlled data session.

Measurement component 206 may be configured to perform one or more measurements to determine whether a later-technology network has become available after switching to an earlier-technology network when a PS data session is in progress. For example, measurement component 206 may be configured to take periodic measurements of the signal strength of the later-technology network. In the case of long-term evolution (LTE), for example, measurements may include measuring the Reference Signal Received Power (RSRP) and/or Reference Signal Received Quality (RSRQ). Measurement component 206 may determine whether each measurement exceeds a defined threshold. In some aspects, the defined threshold may be dependent on the threshold used to determine that a handover from the later-technology network to the earlier-technology network was needed.

In some aspects, UE autonomous later-technology network measurements may be performed by generating short transmission/receptions gaps to measure the radio access technology, and relying on HARQ/RLC for packet recovery during the measurement gaps. The measurements may be configured to minimize user PS service degradation. For example, the measurement component 206 may make measurements when no uplink data is in the buffer and no downlink data has arrived for a defined period of time. In other aspects, measurements may be configured to be performed during compressed mode (CM) gaps or based on discontinuous reception (DRX) in the earlier technology network. In some aspects, where the UE is equipped with dual chipset capabilities (i.e., capable of tuning and measuring the later-technology network while remaining connected in the earlier-technology network), later-technology network measurements may be performed periodically without any user plane interruption in the earlier-technology network.

In accordance with some aspects, measurement component 206 may be configured to target those later-technology network frequencies on which the UE was connected prior to transitioning to the earlier technology network. Multiple later technology networks may be deployed in a communication system. Entering a connection hole for one network does not necessarily indicate that another later-technology network is not available. Accordingly, in other aspects, the measurement component 206 may be configured to target all later-technology network frequencies for which the UE is capable of supporting.

As described above, certain later-technology networks may support only PS calls and not CS calls. Thus, measurement component 206 may be configured to not perform later-technology network measurements when a CS call is occurring on the earlier-technology network. In some aspects, measurement component 206 may be configured to determine the reason that the UE is in CONNECTED mode in the earlier-technology network, and to perform or not perform measurements based on the reasons. For example, if the UE has transitioned from IDLE mode to CONNECTED mode in the earlier-technology network to perform a location update or other short-term data transaction, the measurement component 206 may be configured not to perform measurements. However, if the UE is in CONNECTED mode as a result of a pure data call, measurements may be performed.

In addition to taking measurements, measurement component 206 may also be configured to keep track of the amount of measurements that have taken place. For example, a threshold for a maximum number of measurements or a maximum amount of time for which measurements have been taking place may be made. If the amount of measurements exceeds the threshold, measurement component 206 may cease further measurements. This ensures that measurement component 206 does not waste resources performing measurements when the end of the later-technology network coverage area has been reached rather than simply a coverage hole. In some aspects, measurement component 206 may be configured to extend the time between measurements before completely stopping measurements. For example, the measurement component 206 may perform a first number of measurements within a first time period after detecting the connection and may perform a second, smaller number of measurements within a second time period after detecting the connection. That is, the number of measurements taken within time periods of the same length may decrease over time.

Once measurement component 206 has detected that the later-technology network is again available, it may inform handover trigger 208. Handover trigger 208 may initiate the process of re-connecting to the later-technology network, for example, if the signal strength of the later-technology network is above a certain threshold. This may include, for example, sending a signaling connection release indication to the earlier-technology network to release its connection. The handover trigger 208 may cause the UE to transition to IDLE mode in the earlier-technology network prior to initiating a handover or reselection to the later-technology network.

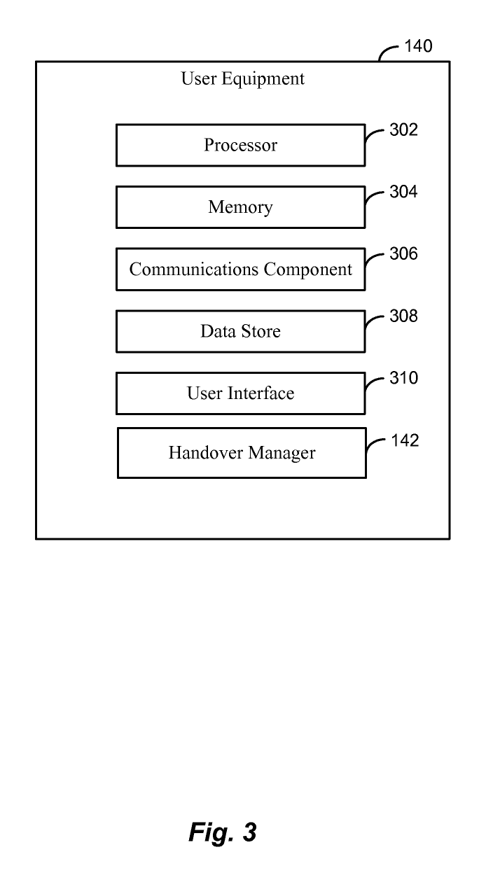

FIG. 3 illustrates UE 140 in greater detail. UE 140 may include a processor 302 for carrying out processing functions associated with one or more components and functions described herein. Processor 302 can include a single or multiple set of processors or multi-core processors. Moreover, processor 302 can be implemented as an integrated processing system and/or a distributed processing system.

UE 140 further includes a memory 304, such as for storing data used herein and/or local versions of applications being executed by processor 302. Memory 304 can include any type of memory usable by a computer, such as random access memory (RAM), read only memory (ROM), tapes, magnetic discs, optical discs, volatile memory, non-volatile memory, and any combination thereof. Applications may include, for example, one or more context-specific pattern matching applications.

Further, UE 140 may include a communications component 306 that provides for establishing and maintaining communications with one or more parties utilizing hardware, software, and services as described herein. Communications component 306 may carry communications between components on UE 140, as well as between UE 140 and external devices, such as devices located across a communications network and/or devices serially or locally connected to UE 140. For example, communications component 306 may include one or more buses, and may further include transmit chain components and receive chain components associated with a transmitter and receiver, respectively, operable for interfacing with external devices.

Additionally, UE 140 may further include a data store 308, which can be any suitable combination of hardware and/or software, that provides for mass storage of information, databases, and programs employed in connection with aspects described herein. For example, data store 308 may be a data repository for applications not currently being executed by processor 302.

UE 140 may additionally include a user interface component 310 operable to receive inputs from a user of UE 140, and further operable to generate outputs for presentation to the user. User interface component 310 may include one or more input devices, including but not limited to a keyboard, a number pad, a mouse, a touch-sensitive display, a navigation key, a function key, a microphone, a voice recognition component, a still camera, a video camera, an audio recorder, and/or any other mechanism capable of receiving an input, or any combination thereof. Further, user interface component 310 may include one or more output devices, including but not limited to a display, a speaker, a haptic feedback mechanism, a printer, any other mechanism capable of presenting an output, or any combination thereof UE 140 may also include handover manager 142, as described above with respect to FIG. 2.

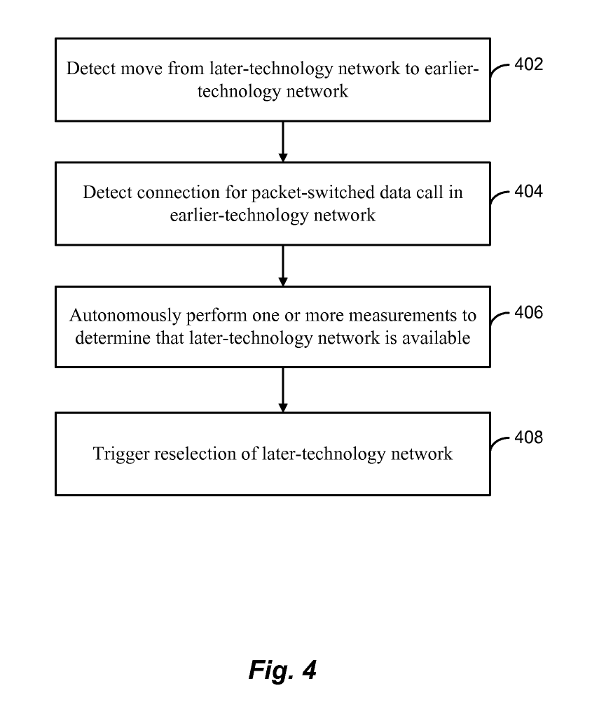

Referring to FIG. 4, one aspect of a method 400 for efficiently performing UE-based handover is shown. For example, method 400 may be performed by UE 140 and/or handover manager 142. As depicted at 402, a move from a later-technology network to an earlier-technology network may be detected. For example, a UE may reach a coverage hole associated with the later-technology network to which it was connected, and may perform a handover to the earlier-technology network where there still exist adequate coverage. As shown at 404, a connection for packet-switched data call in the earlier-technology network may be detected. One or more measurement attempts of the later-technology may then be performed autonomously, in response to detecting the packet-switched data call connection, to detect that the later-technology network is available, as shown at 406. As depicted at 408, upon detecting later-technology network availability, a connection release from the earlier-technology network and a reselection of the later-technology network may be triggered. For example, in some aspects, the reselection may be triggered when the signal strength associated with the later-technology network exceeds a defined threshold, based on the one or more measurements.

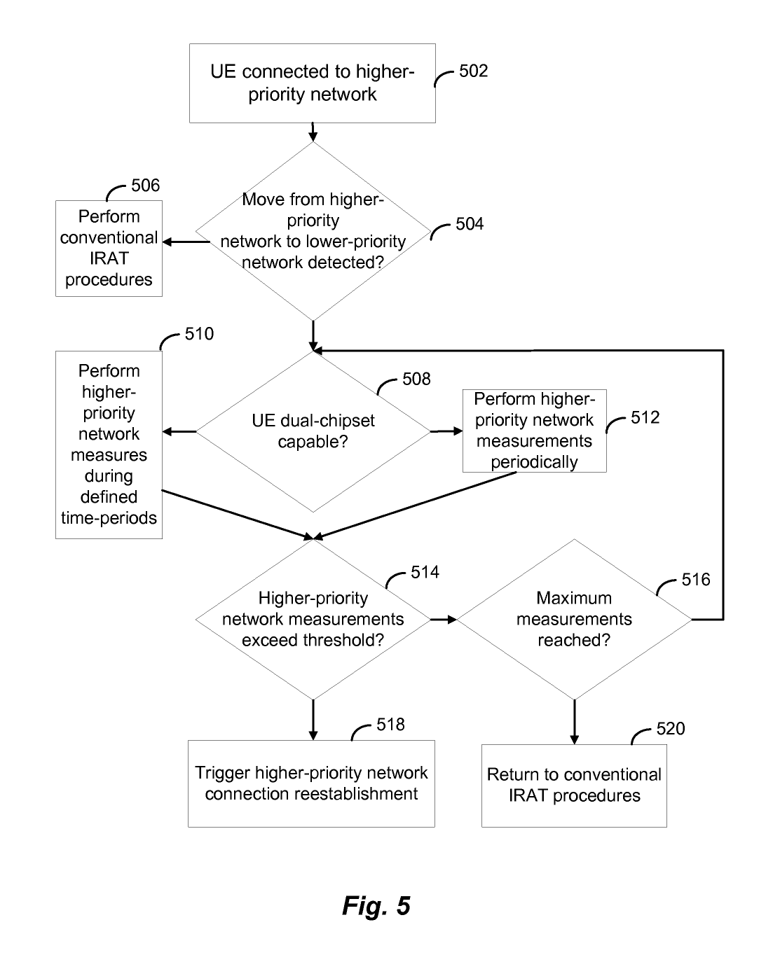

Referring now to FIG. 5, a flowchart illustrating one aspect of a particular use case for UE-based handover back to a higher-priority network from a lower-priority network is provided. In some aspects, a higher-priority network may be defined as a later-technology network, and the lower-priority network may be defined as an earlier-technology network. As shown at 502, the process begins when the UE is connected to the high-priority network. As shown at 504, a determination is made as to whether a move from the higher-priority network to the lower-priority network has been detected. If such a move has not been detected, the UE performs conventional IRAT procedures, as shown at 506. If, however, a move from a higher-priority network to a lower-priority network has been detected, a determination is then made as to whether the UE is dual-chipset capable, as shown at 508. A dual-chipset UE allows the UE to perform measurements for the higher-priority network without interfering with communications using the lower-priority network. As shown at 510, if the UE is not dual-chipset capable, higher-priority network measurements may be performed during defined time-periods. For example, the measurements may be performed based on the UE's CM or DRX schedule in the lower priority network. As shown at 512, the higher-priority network measurements may be performed periodically.

As depicted at 514, a determination may be made as to whether a higher-priority network measurement exceeds a threshold. In some aspects, the threshold may be the same threshold used to signal that a change to the lower-priority network was required. A hysteresis value may be added to the threshold to prevent frequent, temporary changes. If the determination indicates that the threshold has not been exceeded, a determination is made as to whether the maximum amount of measurements has been made, as depicted at 516. For example, a maximum number or time frame for performing measurements may be considered. This prevents continuous measurements when the end of the higher-priority network coverage area has been reached. If the maximum number of measurements, or equivalently the measurement period has not been reached, processing returns to step 508. If the maximum has been reach, convention IRAT procedures are performed, as shown at 520.

As shown at 518, if a higher-priority network measurement has exceeded the threshold, re-establishment of the higher-priority network may be triggered. This may include, for example, sending a signaling connection release indication to the lower-priority network to release the connection. In addition, a reselection process may be initiated to re-establish the connection to the higher-priority network.

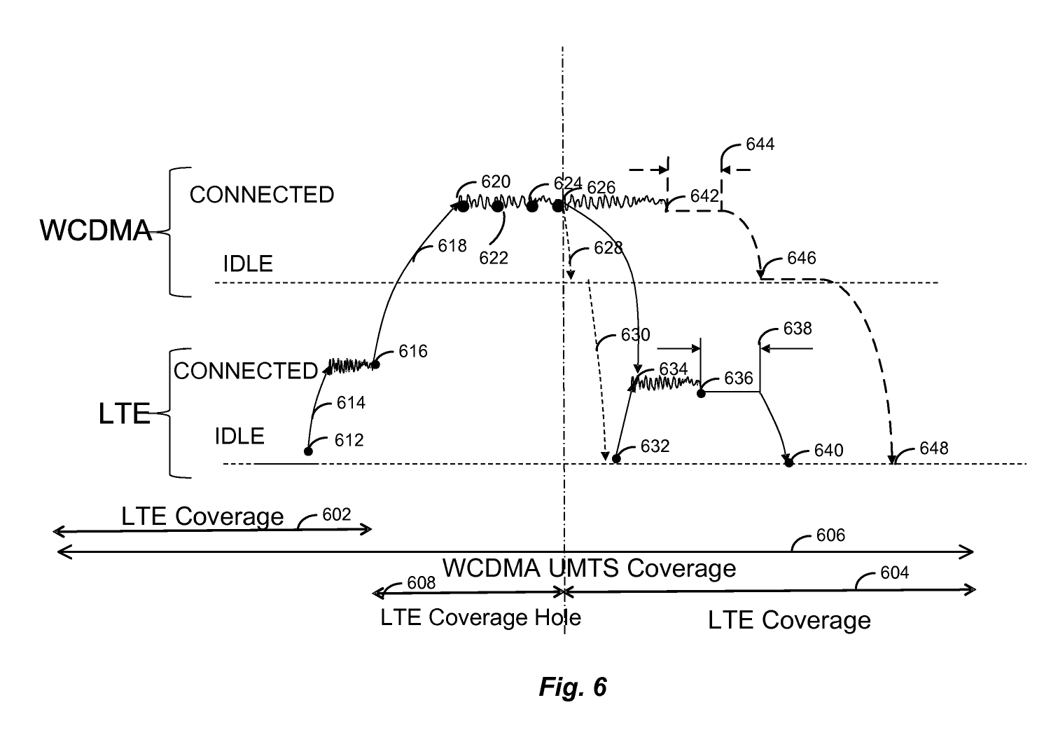

Referring now to FIG. 6, an exemplary time-flow diagram is shown for one use case. As shown, LTE coverage areas 602 and 604 are separated by LTE coverage hole 608. WCDMA UMTS coverage area 606 extends throughout the LTE coverage areas 602 and 604 and the LTE coverage hole 608. As shown at 612, a UE may begin in idle mode and attached to the LTE network. When a data session commences on the UE, the UE transitions to connected mode, as shown at 614. As shown at 616, the UE may encounter LTE coverage hole 608, and may initiate a handover to the WCDMA network, as shown at 618. Once in connected mode on the WCDMA network, the UE begins measuring the LTE network in an attempt to return to the LTE network as soon as possible, as shown at 620, 622, 624, and 626. The measurement at 626 indicates that the LTE network is once again available, and if its signal is above a certain threshold, for example, triggers handover procedures to the LTE network. As shown at 628, the UE may issue a signaling connection release indication to the WCDMA network, causing an IRAT reselection to the LTE network, as shown at 630. As shown at 634, the UE is now in connected mode in the LTE network and can continue the data session. Inactivity is detected at point 636, and an inactivity timer 638 begins a count to determine whether the UE should entire idle mode. Upon expiration of the timer, the UE is placed in idle mode in LTE, as shown at 640.

As shown at 642, without the novel methods described herein, the UE would remain connected to the lower-priority WCDMA network even though the UE has exited the LTE coverage hole 608. The UE would remain on the WCDMA network until inactivity is detected at 642 and the inactivity timer 644 has expired. This would trigger reselection to the LTE network at a much later time, as shown at 646, 648.

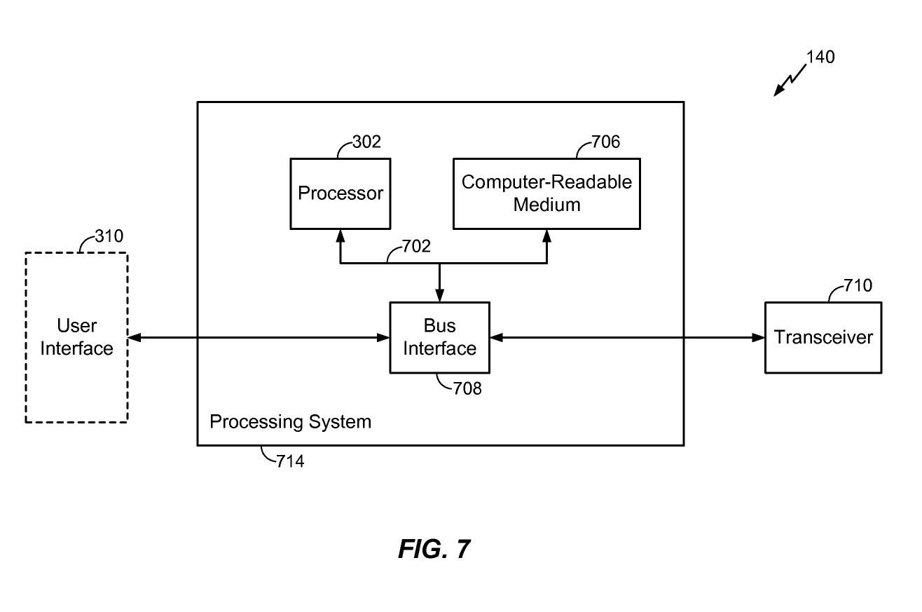

FIG. 7 is a block diagram illustrating an example of a hardware implementation for an apparatus, such as UE 140, employing a processing system 714. In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits including one or more processors, represented generally by the processor 302, and computer-readable media, represented generally by the computer-readable medium 706. The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a means for communicating with various other apparatus over a transmission medium. Depending upon the nature of the apparatus, a user interface 712 (e.g., keypad, display, speaker, microphone, joystick) may also be provided.

The processor 302 is responsible for managing the bus 702 and general processing, including the execution of software stored on the computer-readable medium 706. The software, when executed by the processor 302, causes the processing system 714 to perform the various functions described infra for any particular apparatus. For example, the computer-readable medium 706 may be configured to implement the functions of handover manager 142. The computer-readable medium 706 may also be used for storing data that is manipulated by the processor 702 when executing software.

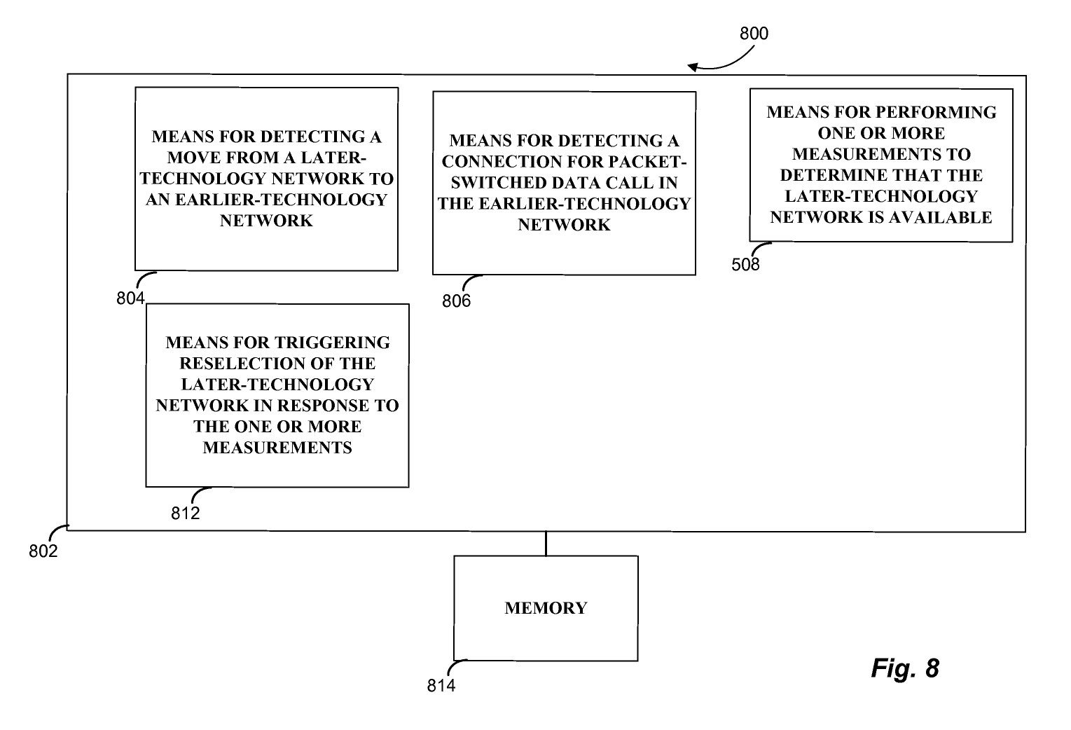

FIG. 8 depicts an apparatus 800 that efficiently performs handovers to a later-technology network. Apparatus 800 can reside at least partially within UE 140. It is to be appreciated that apparatus 800 is represented as including functional blocks, which can represent functions implemented by a processor, software, or combination thereof (e.g., firmware). As such, apparatus 800 includes a logical grouping 802 of electrical components that can act in conjunction. For instance, logical grouping 802 can include means for detecting a move from a later-technology network to an earlier-technology network (Block 804). For example, in an aspect, the means 804 may include handover manager 142, IRAT change detector 202, and/or processor 302. Further, logical grouping 802 can include means for detecting a connection for a packet-switched data call in the earlier-technology network (Block 806). For example, in an aspect, the means 806 can include handover manager 142, PS connection detector 204, and/or or processor 302. Logical grouping 802 may also include means for performing autonomously, in response to determining the connection for the packet-switched data call, one or more measurements to detect that the later-technology network is available (Block 808). For example, the means 808 can include handover manager 142, measurement component 206, and/or processor 302. Also, logical grouping 802 can include means for triggering reselection to the later-technology network when the later-technology network is available (for example, if its signal is above a certain threshold) based on the one or more measurements. (Block 810). For example, in an aspect, the means 810 can include handover manager 142, handover trigger 208, and/or processor 302.

Additionally, apparatus 800 can include a memory 814 that retains instructions for executing functions associated with blocks 804-810. While shown as being external to memory 814, it is to be understood that one or more of blocks 804-810 can exist within memory 814. In an aspect, for example, memory 814 may be the same as or similar to memory 304 or data store 308 (FIG. 3).

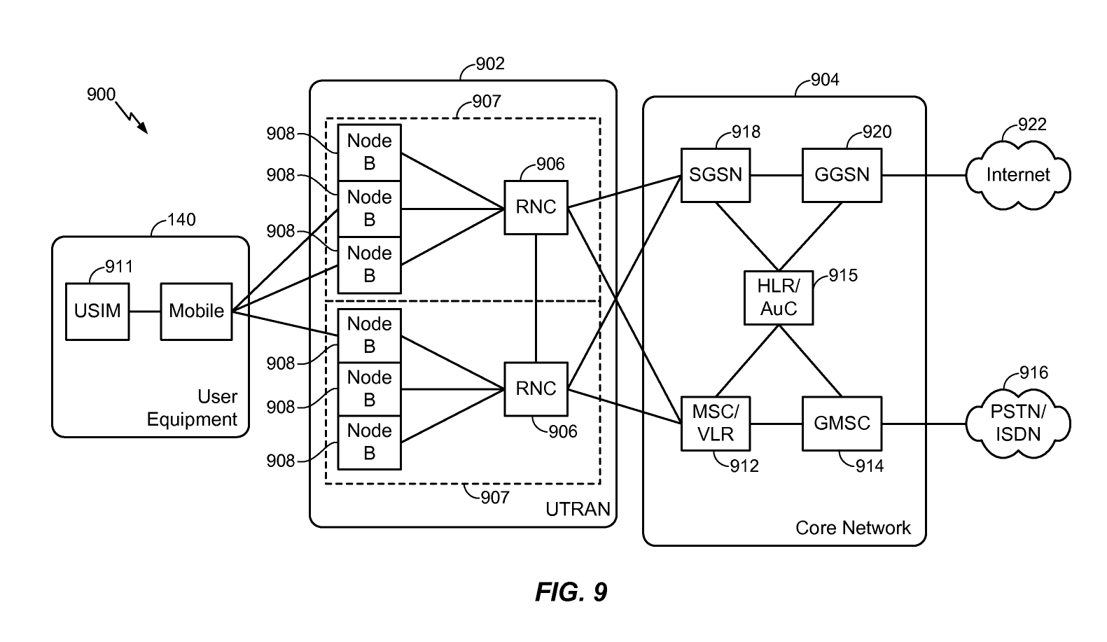

The various concepts presented throughout this disclosure may be implemented across a broad variety of telecommunication systems, network architectures, and communication standards. By way of example and without limitation, the aspects of the present disclosure illustrated in FIG. 9 are presented with reference to a UMTS system 900 employing a W-CDMA air interface. A UMTS network includes three interacting domains: a Core Network (CN) 904, a UMTS Terrestrial Radio Access Network (UTRAN) 902, and User Equipment (UE) 910. In this example, the UTRAN 902 provides various wireless services including telephony, video, data, messaging, broadcasts, and/or other services. The UTRAN 902 may include a plurality of Radio Network Subsystems (RNSs) such as an RNS 907, each controlled by a respective Radio Network Controller (RNC) such as an RNC 906. Here, the UTRAN 902 may include any number of RNCs 906 and RNSs 907 in addition to the RNCs 906 and RNSs 907 illustrated herein. The RNC 906 is an apparatus responsible for, among other things, assigning, reconfiguring and releasing radio resources within the RNS 907. The RNC 906 may be interconnected to other RNCs (not shown) in the UTRAN 902 through various types of interfaces such as a direct physical connection, a virtual network, or the like, using any suitable transport network.

Communication between a UE 910 and a Node B 908 may be considered as including a physical (PHY) layer and a medium access control (MAC) layer. Further, communication between a UE 910 and an RNC 906 by way of a respective Node B 908 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 907 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 908 are shown in each RNS 907; however, the RNSs 907 may include any number of wireless Node Bs. The Node Bs 908 provide wireless access points to a CN 904 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 910 may further include a universal subscriber identity module (USIM) 911, which contains a user's subscription information to a network. For illustrative purposes, one UE 910 is shown in communication with a number of the Node Bs 908. The DL, also called the forward link, refers to the communication link from a Node B 908 to a UE 910, and the UL, also called the reverse link, refers to the communication link from a UE 910 to a Node B 908.

The CN 904 interfaces with one or more access networks, such as the UTRAN 902. As shown, the CN 904 is a GSM core network. However, as those skilled in the art will recognize, the various concepts presented throughout this disclosure may be implemented in a RAN, or other suitable access network, to provide UEs with access to types of CNs other than GSM networks.

The CN 904 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 904 supports circuit-switched services with a MSC 912 and a GMSC 914. In some applications, the GMSC 914 may be referred to as a media gateway (MGW). One or more RNCs, such as the RNC 906, may be connected to the MSC 912. The MSC 912 is an apparatus that controls call setup, call routing, and UE mobility functions. The MSC 912 also includes a VLR that contains subscriber-related information for the duration that a UE is in the coverage area of the MSC 912. The GMSC 914 provides a gateway through the MSC 912 for the UE to access a circuit-switched network 916. The GMSC 914 includes a home location register (HLR) 295 containing subscriber data, such as the data reflecting the details of the services to which a particular user has subscribed. The HLR is also associated with an authentication center (AuC) that contains subscriber-specific authentication data. When a call is received for a particular UE, the GMSC 914 queries the HLR 915 to determine the UE's location and forwards the call to the particular MSC serving that location.

The CN 904 also supports packet-data services with a serving GPRS support node (SGSN) 918 and a gateway GPRS support node (GGSN) 920. GPRS, which stands for General Packet Radio Service, is designed to provide packet-data services at speeds higher than those available with standard circuit-switched data services. The GGSN 920 provides a connection for the UTRAN 902 to a packet-based network 922. The packet-based network 922 may be the Internet, a private data network, or some other suitable packet-based network. The primary function of the GGSN 920 is to provide the UEs 910 with packet-based network connectivity. Data packets may be transferred between the GGSN 920 and the UEs 910 through the SGSN 918, which performs primarily the same functions in the packet-based domain as the MSC 912 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 908 and a UE 910. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 910 provides feedback to the node B 908 over the HS-DPCCH to indicate whether it correctly decoded a packet on the downlink.

HS-DPCCH further includes feedback signaling from the UE 910 to assist the node B 908 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance That is, in an aspect of the disclosure, the node B 908 and/or the UE 910 may have multiple antennas supporting MIMO technology. The use of MIMO technology enables the node B 908 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 910 to increase the data rate or to multiple UEs 910 to increase the overall system capacity. This is achieved by spatially precoding each data stream and then transmitting each spatially precoded stream through a different transmit antenna on the downlink. The spatially precoded data streams arrive at the UE(s) 910 with different spatial signatures, which enables each of the UE(s) 910 to recover the one or more the data streams destined for that UE 910. On the uplink, each UE 910 may transmit one or more spatially precoded data streams, which enables the node B 908 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport block sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

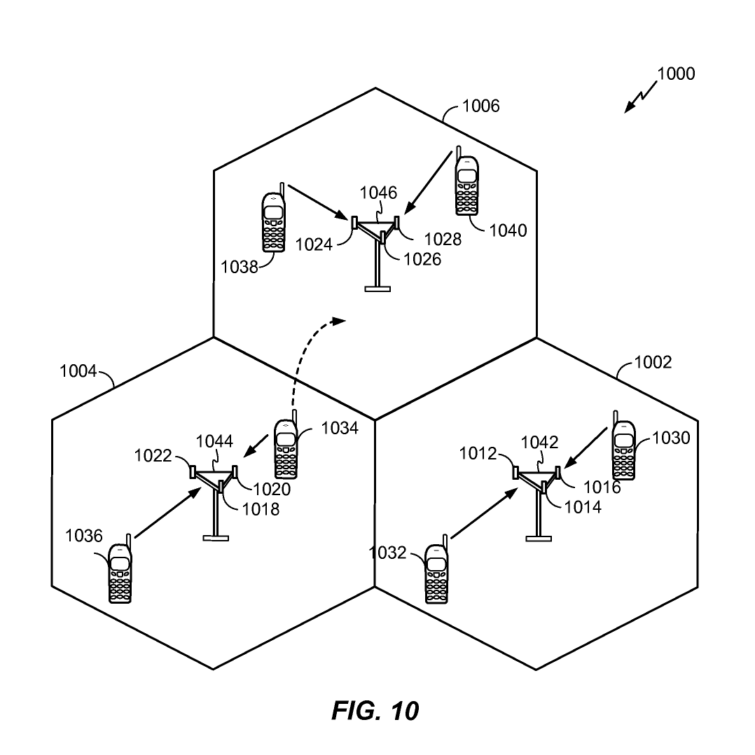

Referring to FIG. 10, an access network 1000 in a UTRAN architecture is illustrated. The multiple access wireless communication system includes multiple cellular regions (cells), including cells 1002, 1004, and 1006, each of which may include one or more sectors. The multiple sectors can be formed by groups of antennas with each antenna responsible for communication with UEs in a portion of the cell. For example, in cell 1002, antenna groups 1012, 1014, and 1016 may each correspond to a different sector. In cell 1004, antenna groups 1018, 1020, and 1022 each correspond to a different sector. In cell 1006, antenna groups 1024, 1026, and 1028 each correspond to a different sector. The cells 1002, 1004 and 1006 may include several wireless communication devices, e.g., User Equipment or UEs, which may be in communication with one or more sectors of each cell 1002, 1004 or 1006. For example, UEs 1030 and 1032 may be in communication with Node B 1042, UEs 1034 and 1036 may be in communication with Node B 1044, and UEs 1038 and 1040 can be in communication with Node B 1046. Here, each Node B 1042, 1044, 1046 is configured to provide an access point to a CN 904 (see FIG. 9) for all the UEs 1030, 1032, 1034, 1036, 1038, 1040 in the respective cells 1002, 1004, and 1006.

As the UE 1034 moves from the illustrated location in cell 1004 into cell 1006, a serving cell change (SCC) or handover may occur in which communication with the UE 1034 transitions from the cell 1004, which may be referred to as the source cell, to cell 1006, which may be referred to as the target cell. Management of the handover procedure may take place at the UE 1034, at the Node Bs corresponding to the respective cells, at a radio network controller 906 (see FIG. 9), or at another suitable node in the wireless network. For example, during a call with the source cell 1004, or at any other time, the UE 1034 may monitor various parameters of the source cell 1004 as well as various parameters of neighboring cells such as cells 1006 and 1002. Further, depending on the quality of these parameters, the UE 1034 may maintain communication with one or more of the neighboring cells. During this time, the UE 1034 may maintain an Active Set, that is, a list of cells that the UE 1034 is simultaneously connected to (i.e., the UTRA cells that are currently assigning a downlink dedicated physical channel DPCH or fractional downlink dedicated physical channel F-DPCH to the UE 1034 may constitute the Active Set).

The modulation and multiple access scheme employed by the access network 1000 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

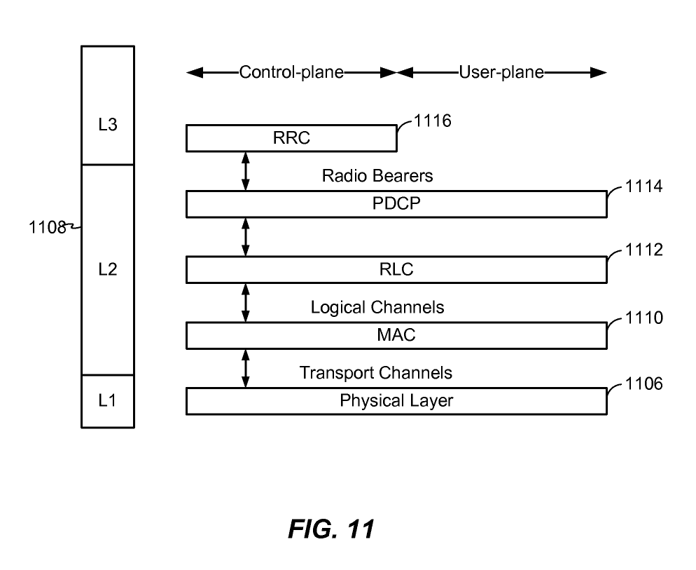

The radio protocol architecture may take on various forms depending on the particular application. An example for an HSPA system will now be presented with reference to FIG. 11. FIG. 11 is a conceptual diagram illustrating an example of the radio protocol architecture for the user and control planes.

Turning to FIG. 11, the radio protocol architecture for the UE and node B is shown with three layers: Layer 1, Layer 2, and Layer 3. Layer 1 is the lowest lower and implements various physical layer signal processing functions. Layer 1 will be referred to herein as the physical layer 1106. Layer 2 (L2 layer) 1108 is above the physical layer 1106 and is responsible for the link between the UE and node B over the physical layer 1106.

In the user plane, the L2 layer 1108 includes a media access control (MAC) sublayer 1110, a radio link control (RLC) sublayer 1112, and a packet data convergence protocol (PDCP) 1114 sublayer, which are terminated at the node B on the network side. Although not shown, the UE may have several upper layers above the L2 layer 1108 including a network layer (e.g., IP layer) that is terminated at a PDN gateway on the network side, and an application layer that is terminated at the other end of the connection (e.g., far end UE, server, etc.).

The PDCP sublayer 1114 provides multiplexing between different radio bearers and logical channels. The PDCP sublayer 1114 also provides header compression for upper layer data packets to reduce radio transmission overhead, security by ciphering the data packets, and handover support for UEs between node Bs. The RLC sublayer 1112 provides segmentation and reassembly of upper layer data packets, retransmission of lost data packets, and reordering of data packets to compensate for out-of-order reception due to hybrid automatic repeat request (HARQ). The MAC sublayer 1110 provides multiplexing between logical and transport channels. The MAC sublayer 1110 is also responsible for allocating the various radio resources (e.g., resource blocks) in one cell among the UEs. The MAC sublayer 1110 is also responsible for HARQ operations.

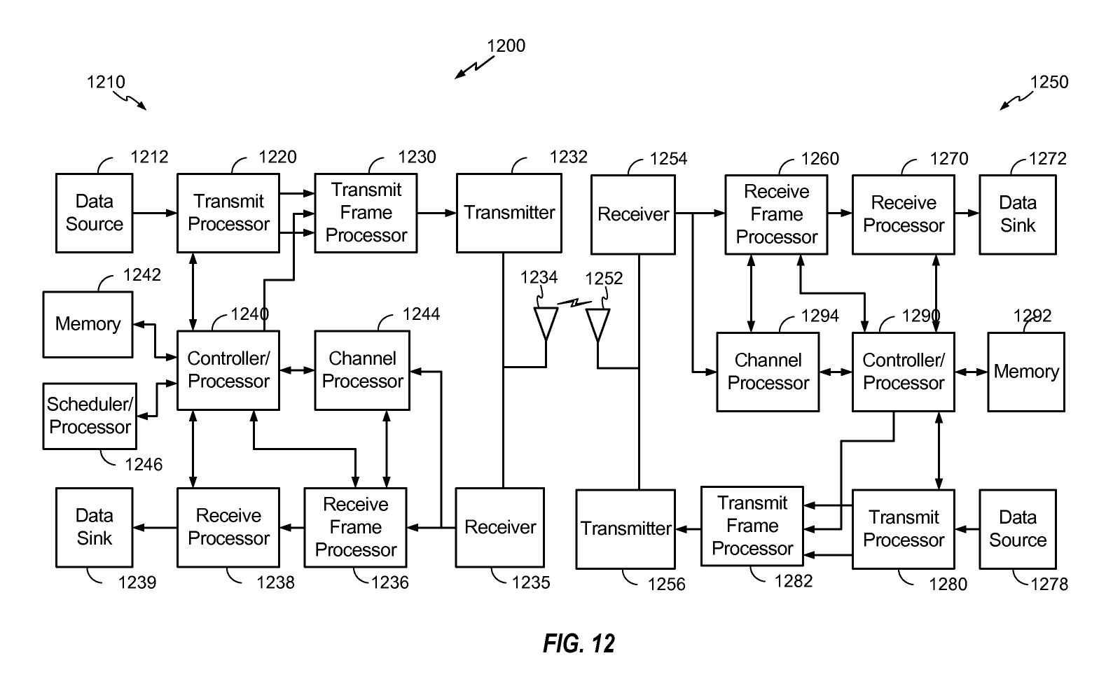

FIG. 12 is a block diagram of a Node B 1210 in communication with a UE 1250, where the Node B 1210 may be the Node B 908 in FIG. 9, and the UE 1250 may be the UE 910 in FIG. 9. In the downlink communication, a transmit processor 1220 may receive data from a data source 1212 and control signals from a controller/processor 1240. The transmit processor 1220 provides various signal processing functions for the data and control signals, as well as reference signals (e.g., pilot signals). For example, the transmit processor 1220 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1244 may be used by a controller/processor 1240 to determine the coding, modulation, spreading, and/or scrambling schemes for the transmit processor 1220. These channel estimates may be derived from a reference signal transmitted by the UE 1250 or from feedback from the UE 1250. The symbols generated by the transmit processor 1220 are provided to a transmit frame processor 1230 to create a frame structure. The transmit frame processor 1230 creates this frame structure by multiplexing the symbols with information from the controller/processor 1240, resulting in a series of frames. The frames are then provided to a transmitter 1232, which provides various signal conditioning functions including amplifying, filtering, and modulating the frames onto a carrier for downlink transmission over the wireless medium through antenna 1234. The antenna 1234 may include one or more antennas, for example, including beam steering bidirectional adaptive antenna arrays or other similar beam technologies.

At the UE 1250, a receiver 1254 receives the downlink transmission through an antenna 1252 and processes the transmission to recover the information modulated onto the carrier. The information recovered by the receiver 1254 is provided to a receive frame processor 1260, which parses each frame, and provides information from the frames to a channel processor 1294 and the data, control, and reference signals to a receive processor 1270. The receive processor 1270 then performs the inverse of the processing performed by the transmit processor 1220 in the Node B 1210. More specifically, the receive processor 1270 descrambles and despreads the symbols, and then determines the most likely signal constellation points transmitted by the Node B 1210 based on the modulation scheme. These soft decisions may be based on channel estimates computed by the channel processor 1294. The soft decisions are then decoded and deinterleaved to recover the data, control, and reference signals. The CRC codes are then checked to determine whether the frames were successfully decoded. The data carried by the successfully decoded frames will then be provided to a data sink 1272, which represents applications running in the UE 1250 and/or various user interfaces (e.g., display). Control signals carried by successfully decoded frames will be provided to a controller/processor 1290. When frames are unsuccessfully decoded by the receiver processor 1270, the controller/processor 1290 may also use an acknowledgement (ACK) and/or negative acknowledgement (NACK) protocol to support retransmission requests for those frames.

In the uplink, data from a data source 1278 and control signals from the controller/processor 1290 are provided to a transmit processor 1280. The data source 1278 may represent applications running in the UE 1250 and various user interfaces (e.g., keyboard). Similar to the functionality described in connection with the downlink transmission by the Node B 1210, the transmit processor 1280 provides various signal processing functions including CRC codes, coding and interleaving to facilitate FEC, mapping to signal constellations, spreading with OVSFs, and scrambling to produce a series of symbols. Channel estimates, derived by the channel processor 1294 from a reference signal transmitted by the Node B 1210 or from feedback contained in the midamble transmitted by the Node B 1210, may be used to select the appropriate coding, modulation, spreading, and/or scrambling schemes. The symbols produced by the transmit processor 1280 will be provided to a transmit frame processor 1282 to create a frame structure. The transmit frame processor 1282 creates this frame structure by multiplexing the symbols with information from the controller/processor 1290, resulting in a series of frames. The frames are then provided to a transmitter 1256, which provides various signal conditioning functions including amplification, filtering, and modulating the frames onto a carrier for uplink transmission over the wireless medium through the antenna 1252.

The uplink transmission is processed at the Node B 1210 in a manner similar to that described in connection with the receiver function at the UE 1250. A receiver 1235 receives the uplink transmission through the antenna 1234 and processes the transmission to recover the information modulated onto the carrier. The information recovered by the receiver 1235 is provided to a receive frame processor 1236, which parses each frame, and provides information from the frames to the channel processor 1244 and the data, control, and reference signals to a receive processor 1238. The receive processor 1238 performs the inverse of the processing performed by the transmit processor 1280 in the UE 1250. The data and control signals carried by the successfully decoded frames may then be provided to a data sink 1239 and the controller/processor, respectively. If some of the frames were unsuccessfully decoded by the receive processor, the controller/processor 1240 may also use an acknowledgement (ACK) and/or negative acknowledgement (NACK) protocol to support retransmission requests for those frames.

The controller/processors 1240 and 1290 may be used to direct the operation at the Node B 1210 and the UE 1250, respectively. For example, the controller/processors 1240 and 1290 may provide various functions including timing, peripheral interfaces, voltage regulation, power management, and other control functions. The computer readable media of memories 1242 and 1292 may store data and software for the Node B 1210 and the UE 1250, respectively. A scheduler/processor 1246 at the Node B 1210 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
detecting, by a user equipment, movement from a later-technology network to an earlier-technology network;
detecting a connection for a packet-switched data call in the earlier-technology network;
performing autonomously, in response to determining the connection for the packet-switched data call, one or more measurements to determine that a signal from the later-technology network is available; and
triggering a connection release from the earlier-technology network and a reselection to the later-technology network when the later-technology network is available based on the one or more measurements.

2. The method of claim 1, wherein performing one or more measurements comprises determining whether a signal strength associated with the later-technology network exceeds a threshold.

3. The method of claim 1, wherein performing, autonomously, the one or more measurements comprises performing the one or more measurements during compressed mode (CM) gaps or based on discontinuous reception (DRX).

4. The method of claim 1, wherein performing, autonomously, the one or more measurements comprises:
generating short transmission/reception gaps to measure a signal strength associated with the later-technology network; and
relying on HARQ/RLC for packet recovery during the short transmission/reception gaps.

5. The method of claim 1, wherein triggering a reselection to the later-technology network comprising:
transmitting a network release message to the earlier-technology network;
performing a reselection to the later-technology network; and
re-establishing a packet-switched data call with the later-technology network.

6. The method of claim 1, wherein the earlier-technology network is a 2G network or a 3G network, and the later-technology network is a 4G or later network.

7. The method of claim 1, wherein performing one or more measurements comprises:
performing a first measurement;
upon determining that the first measurement does not exceed a defined threshold, determining whether a maximum number of measurements or a maximum amount of time has been reached; and
upon determining that the maximum number of measurements or the maximum amount of time has not been reached, performing additional measurements until a measurement exceeds the defined threshold or the maximum number of measurements or the maximum amount of time is reached.

8. The method of claim 1, wherein performing one or more measurements further comprises performing a first number of measurements in a first time period after detecting the connection and performing a second number of measurements in a second time period after detecting the connection, wherein the second time period is later than the first time period, and wherein the second number of measurements is less than the first number of measurements when the first time period and the second time period are equal.

9. The method of claim 1, further comprising determining that the movement from the later-technology network to the earlier-technology network corresponds to an end of coverage of the later-technology network, and canceling the performing of the one or more measurements to determine that the later-technology network is available.

10. A non-transitory computer readable medium, comprising:
at least one set of instructions for causing a computer to detect movement from a later-technology network to an earlier-technology network;
at least one set of instructions for causing the computer to detect a connection for a packet-switched data call in the earlier-technology network;
at least one set of instructions for causing the computer to perform autonomously, in response to determining the connection for the packet-switched data call, one or more measurements to determine that a signal from the later-technology network is available; and
at least one set of instructions for causing the computer to release a connection from the earlier-technology network and reselect the later-technology network when the later-technology network is available based on the one or more measurements.

11. An apparatus, comprising:
means for detecting movement from a later-technology network to an earlier-technology network;
means for detecting a connection for a packet-switched data call in the earlier-technology network;
means for performing, autonomously and in response to determining the connection for the packet-switched data call, one or more measurements to determine that a signal from the later-technology network is available; and
means for triggering a connection release from the earlier-technology network and a reselection to the later-technology network when the later-technology network is available in response to the one or more measurements.

12. An apparatus for wireless communication, comprising:
at least one processor configured to detect movement from a later-technology network to an earlier-technology network; detect a connection for a packet-switched data call in the earlier-technology network; perform, autonomously and in response to determining the connection for the packet-switched data call, one or more measurements to determine that a signal from the later-technology network is available; and trigger a connection release from the earlier-technology network and a reselection of the later-technology network when the later-technology network is available based on the one or more measurements; and
a memory coupled to the at least one processor.

13. The apparatus of claim 12, wherein the at least one processor is further configured to perform the one or more measurements by determining whether a signal strength associated with the later-technology network exceeds a threshold.

14. The apparatus of claim 12, wherein the at least one processor is further configured to perform, autonomously, the one or more measurements by performing the one or more measurements during compressed mode (CM) gaps or based on discontinuous reception (DRX).

15. The apparatus of claim 12, wherein the at least one processor is further configured to:
generate short transmission/reception gaps to measure a signal strength associated with the later-technology network; and
rely on HARQ/RLC for packet recovery during the short transmission/receptions gaps.

16. The apparatus of claim 12, wherein the at least one processor is further configured to:
transmit a network release message to the earlier-technology network;
perform a reselection to the later-technology network; and
re-establish a packet-switched data call with the later-technology network.

17. The apparatus of claim 12, wherein the earlier-technology network is a 2G network or a 3G network, and the later-technology network is a 4G or later network.

18. The apparatus of claim 12, wherein the at least one processor is further configured to performing the one or more measurements by:
performing a first measurement;
upon determining that the first measurement does not exceed a defined threshold, determining whether a maximum number of measurements or a maximum amount of time has been reached; and
upon determining that the maximum number of measurements or the maximum amount of time has not been reached, performing additional measurements until a measurement exceeds the defined threshold or the maximum number of measurements or the maximum amount of time is reached.

19. The apparatus of claim 12, wherein the at least one processor is further configured to:
perform a first number of measurements in a first time period after detecting the connection and perform a second number of measurements in a second time period after detecting the connection, wherein the second time period is later than the first time period, and wherein the second number of measurements is less than the first number of measurements when the first time period and the second time period are equal.

20. The apparatus of claim 12, wherein the at least one processor is further configured to:
determine that the movement from the later-technology network to the earlier-technology network corresponds to an end of coverage of the later-technology network; and
cancel the performing of the one or more measurements to determine that the later-technology network is available.
